(19) United States
(12) Patent Application Publication
(10) Pub. No.: US 2025/0022119 A1
(43) Pub. Date: Jan. 16, 2025

(54) IMAGE PROCESSING APPARATUS AND METHOD

(71) Applicants: Hyundai Motor Company, Seoul (KR); Kia Corporation, Seoul (KR); EFICAR Inc., Seongnam-si (KR)

(72) Inventor: Sang Gyun Park, Suwon-si (KR)

(21) Appl. No.: 18/507,185

(22) Filed: Nov. 13, 2023

(30) Foreign Application Priority Data
Jul. 12, 2023 (KR) 10-2023-0090538

(51) Int. Cl. G06T 7/00; G06T 7/13; G06T 7/50; G06T 7/62; G06T 11/60; G06V 10/56; G06V 10/60

(52) U.S. Cl. CPC G06T 7/0008; G06T 7/13; G06T 7/50; G06T 7/62; G06T 11/60; G06V 10/56; G06V 10/60; G06T 2207/20132

(57) ABSTRACT

In an embodiment, an image processing apparatus can include a memory storing computer-executable code, and at least one processor configured to access the memory and execute the instructions. The code comprises instructions for the at least one processor to generate an input image by preprocessing an image around a part, based on detecting the part from the image, apply the input image to an image analysis model to obtain a defect type and a defect size of the part detected from the image, and apply the defect type and the defect size to the input image to generate an output image.

### CROSS-REFERENCE TO RELATED APPLICATIONS

This application claims the benefit of Korean Patent Application No. 10-2023-0090538, filed on Jul. 12, 2023, which application is hereby incorporated herein by reference.

### TECHNICAL FIELD

The present disclosure relates to an image processing apparatus and a method thereof.

### BACKGROUND

The process of identifying defects of used car parts is a process in which a worker visually and directly inspects the used parts and identifies defects in the used parts. Particularly, it is estimated that tens of thousands of vehicles are scrapped each year in Korea.

Dozens of parts in the scrapped vehicles are discarded even though they are able to be recycled.

Because the worker directly identifies defects in the used car parts with his or her own eyes in the above-mentioned identification process, it takes a very long time. For example, due to the nature of used parts, one identification process is required for one thing. In addition, defect information based on the subjective judgment of the worker may not be objective.

To address such problems, there is a need to develop a technology of automatically identifying defects of used car parts. Furthermore, there is a need to develop a technology of automatically recording the identified defect information to remove an error about a handwritten record.

### SUMMARY

The present disclosure relates to an image processing apparatus and a method thereof, and more particularly, relates to technologies for obtaining a defect type and a defect size of a part included in an image.

In an embodiment of the present disclosure, the above-mentioned problems occurring in the prior art can be solved while advantages achieved by the prior art are maintained intact.

In an embodiment of the present disclosure, an image processing apparatus for obtaining a defect type and a defect size of a detected part based on detecting the part from an image can reduce a time for identifying a defect of a used car part, exclude subjective judgment of a user to increase the reliability of the state of the used part, and maintain certain inspection quality, and a method thereof.

In an embodiment of the present disclosure, an image processing apparatus for calculating availability of a part and a range of breakage of the part based on a defect size obtained from an image analysis model can provide stakeholders associated with the transaction of the used car part with accurate and reliable information about the state of the used part and exclude subjective judgment of a user to overcome the limit of the inspection result based on the experience of the user, and a method thereof.

In an embodiment of the present disclosure, an image processing apparatus for increasing the accuracy of entering information for the sale of a used part through an interface can receive or provide an image, develop a healthy trading ecosystem for used car parts to develop parts industry, and reduce carbon emissions due to the activation of the used parts industry, and a method thereof.

Technical problems solved by embodiments of the present disclosure are not necessarily limited to the aforementioned problems, and any other technical problems not mentioned herein can be clearly understood from the following description by those skilled in the art to which the present disclosure pertains.

According to an embodiment of the present disclosure, an image processing apparatus may include a memory storing computer-executable instructions and at least one processor that accesses the memory and executes the instructions. The at least one processor may generate an input image by preprocessing an image around a part, based on detecting the part from the image, may apply the input image to an image analysis model to obtain a defect type and a defect size of the part detected from the image, and may apply the defect type and the defect size to the input image to generate an output image.

In an embodiment, the at least one processor may generate the input image by using a cropped image including a predetermined area including all portions of the detected part and may apply normalization to pixel values included in the cropped image depending on a predetermined pixel interval to change the pixel values.

In an embodiment, the at least one processor may change a channel of the cropped image, the pixel values of which are changed, to a first channel or a second channel, and may change a plurality of pixel values included in the cropped image, the pixel values of which are changed, to a one-dimensional array in an order of channel features included in the first channel changes to the first channel including a plurality of channels, based on the channel of the crop image, the pixel values of which are changed.

In an embodiment, the at least one processor may concatenate the image, the input image, and the output image, and may transmit the concatenated image to an image storage server.

In an embodiment, the at least one processor may adjust at least one of a color feature of the input image, an edge feature of the input image, a polygon feature of the input image, a saturation feature of the input image, a color temperature feature of the input image, a definition feature of the input image, a contrast feature of the input image, a blur feature of the input image, or a brightness feature of the input image, or any combination thereof, and applies the image in which the at least one is adjusted to the image analysis model to obtain the defect type and the defect size.

In an embodiment, the defect type may include a first defect including a surface scratch of a painted surface area of the part, a second defect can include shapeshifting of the part, a third defect in which a portion or all of a shape of the part can be different from an existing shape of the part, and a fourth defect can include a gap generated in a joint of the part.

In an embodiment, the at least one processor may calculate availability of the part and a range of breakage of the part, based on the obtained defect size.

In an embodiment, the at least one processor may provide an interface to receive the image from a parts supplier supplying used parts, and may provide the parts supplier with the output image, the defect type, and the defect size stored in an image storage server through the interface.

In an embodiment, the at least one processor may generate the image analysis model including a plurality of pooling layers and a plurality of unpooling layers, based on the image analysis model being a U-Net neural network model, and may train the image analysis model, using a loss function defined as the sum of losses between the input image and the output image.

In an embodiment, the plurality of pooling layers may be connected with non-linearity of a rectified linear unit (ReLU) function included in the image analysis model. The image analysis model may include a skip connection from the plurality of pooling layers to the plurality of unpooling layers.

According to an embodiment of the present disclosure, an image processing method may include generating an input image by preprocessing an image around a part, based on detecting the part from the image, applying the input image to an image analysis model to obtain a defect type and a defect size of the part detected from the image, and applying the defect type and the defect size to the input image to generate an output image.

In an embodiment, the generating of the input image may include generating the input image by use of a cropped image including a predetermined area including all portions of the detected part and applying normalization to pixel values included in the cropped image depending on a predetermined pixel interval to change the pixel values.

In an embodiment, the image processing method may further include changing a channel of the crop image, the pixel values of which are changed, to a first channel or a second channel, and changing a plurality of pixel values included in the crop image, the pixel values of which are changed, to a one-dimensional array in an order of channel features included in the first channel, based on that the channel of the cropped image, the pixel values of which are changed, changes to the first channel including a plurality of channels.

In an embodiment, the image processing method may further include concatenating the image, the input image, and the output image, and transmitting the concatenated image to an image storage server.

In an embodiment, the obtaining of the defect type and the defect size may include adjusting at least one of a color feature of the input image, an edge feature of the input image, a polygon feature of the input image, a saturation feature of the input image, a color temperature feature of the input image, a definition feature of the input image, a contrast feature of the input image, a blur feature of the input image, a brightness feature of the input image, or any combination thereof, and applying the image in which the at least one is adjusted to the image analysis model to obtain the defect type and the defect size.

In an embodiment, the defect type may include a first defect including a surface scratch of a painted surface area of the part, a second defect including shapeshifting of the part, a third defect in which a portion or all of a shape of the part is different from an existing shape of the part, and a fourth defect including a gap generated in a joint of the part.

In an embodiment, the image processing method may further include calculating availability of the part and a range of breakage of the part, based on the obtained defect size.

In an embodiment, the image processing method may further include providing an interface to receive the image from a parts supplier supplying used parts, and providing the parts supplier with the output image, the defect type, and the defect size stored in an image storage server through the interface.

In an embodiment, the image processing method may further include generating the image analysis model including a plurality of pooling layers and a plurality of unpooling layers, based on the image analysis model being a U-Net neural network, and training the image analysis model, using a loss function defined as the sum of losses between the input image and the output image. The plurality of pooling layers may be connected with non-linearity of a rectified linear unit (ReLU) function included in the image analysis model. The image analysis model may include a skip connection from the plurality of pooling layers to the plurality of unpooling layers.

According to an embodiment of the present disclosure, an image storage server may include receiving at least one of a defect type and a defect size of a part of a vehicle, the defect type and the defect size being obtained by applying an image including the part to an image analysis model, the image, or any combination thereof, from an image processing apparatus, providing an interface to receive a query about information of a used part from a parts supplier supplying used parts, and providing the parts supplier with at least one of the defect type, the defect size, the image, or any combination thereof, based on receiving the query about the information of the used part through the interface.

### BRIEF DESCRIPTION OF THE DRAWINGS

The above and other features and advantages of embodiments of the present disclosure can be more apparent from the following detailed description taken in conjunction with the accompanying drawings, in which:

FIG. 1 is a drawing illustrating an image processing apparatus, according to an embodiment of the present disclosure;

FIG. 2 is a flowchart for describing an image processing method, according to an embodiment of the present disclosure;

FIG. 3 is a drawing illustrating a method for training an image analysis model in an image processing apparatus, according to an embodiment of the present disclosure;

FIG. 4 is a drawing illustrating a process of processing an image in an image processing apparatus, according to an embodiment of the present disclosure;

FIG. 5 is a drawing illustrating a method for applying an input image to an image analysis module in an image processing apparatus, according to an embodiment of the present disclosure;

FIG. 6 is a drawing illustrating a process of querying for an output image in an image processing apparatus, according to an embodiment of the present disclosure;

FIG. 7 is a drawing illustrating a generated output image in an image processing apparatus, according to an embodiment of the present disclosure;

FIG. 8 is a drawing illustrating defect information paired with a generated output image in an image processing apparatus, according to an embodiment of the present disclosure;

FIG. 9 is a drawing illustrating a generated output image in an image processing apparatus, according to an embodiment of the present disclosure;

FIG. 10 is a drawing illustrating defect information paired with a generated output image in an image processing apparatus, according to an embodiment of the present disclosure; and

FIG. 11 illustrates a computing system associated with an image processing apparatus and a method thereof, according to an embodiment of the present disclosure.

### DETAILED DESCRIPTION OF ILLUSTRATIVE EMBODIMENTS

Hereinafter, some embodiments of the present disclosure will be described in detail with reference to the example drawings. In the drawings, the same reference numerals will be used throughout to designate the same or equivalent elements. In addition, a detailed description of well-known features or functions will be ruled out in order not to unnecessarily obscure the gist of the present disclosure. Hereinafter, various embodiments of the present disclosure may be described with reference to the accompanying drawings. However, it should be understood that this is not intended to limit the present disclosure to specific implementation forms and includes various modifications, equivalents, and/or alternatives of embodiments of the present disclosure. With regard to description of drawings, same or similar components may be marked by same or similar reference numerals.

In describing elements of example embodiments of the present disclosure, the terms “first,” “second,” “A,” “B,” “(a),” “(b),” and the like, may be used herein. These terms can be merely used to distinguish one component from another component, but do not necessarily limit the corresponding components, irrespective of the order or priority of the corresponding components. Furthermore, unless otherwise defined, all terms including technical and scientific terms used herein can be interpreted as is customary in the art to which the present disclosure pertains, for example. It can be understood that terms used herein can be interpreted as having a meaning that is consistent with their meaning in the context of this present disclosure and the relevant art, and not interpreted in an idealized or overly formal sense unless expressly so defined herein. For example, the terms, such as “first,” “second,” “1st,” “2nd,” or the like, used in the present disclosure may be used to refer to various components regardless of the order and/or the priority and to distinguish one component from another component, but do not necessarily limit the components. For example, a first user device and a second user device indicate different user devices, irrespective of the order and/or priority. For example, without departing the scope of the present disclosure, a first component may be referred to as a second component, and similarly, a second component may be referred to as a first component.

In the present disclosure, the expressions “have,” “may have,” “include,” and “comprise,” or “may include” and “may comprise” indicate existence of corresponding features (e.g., components such as numeric values, functions, operations, or parts), but do not exclude presence of additional features.

It can be understood that when a component (e.g., a first component) is referred to as being “(operatively or communicatively) coupled with/to” or “connected to” another component (e.g., a second component), it can be directly coupled with/to or connected to the other component or an intervening component (e.g., a third component) may be present. In contrast, when a component (e.g., a first component) is referred to as being “directly coupled with/to” or “directly connected to” another component (e.g., a second component), it should be understood that there is no intervening component (e.g., a third component).

According to a situation, the expression “configured to” used in the present disclosure may be used exchangeably with, for example, the expression “suitable for,” “having the capacity to,” “designed to,” “adapted to,” “made to,” or “capable of.”

The term “configured to” must not mean only “specifically designed to” in hardware. Instead, the expression “a device configured to” may mean that the device is “capable of” operating together with another device or other parts. For example, a “processor configured to perform A, B, and C” may mean a generic-purpose processor (e.g., a central processing unit (CPU) or an application processor) that may perform corresponding operations by executing one or more software programs or code, which may be stored in a memory device. Terms used in the present disclosure can be used to only describe specified embodiments and are not necessarily intended to limit the scope of another embodiment. Terms of a singular form may include plural forms unless the context clearly indicates otherwise. All the terms used herein, which include technical or scientific terms, may have the same meaning that is generally understood by a person skilled in the art described in the present disclosure. It will be further understood that terms, which are defined in a dictionary and commonly used, can also be interpreted as is customary in the relevant related art and not in an idealized or overly formal detect unless expressly so defined herein in various embodiments of the present disclosure. In some cases, even though terms are terms that are defined in the specification, they may not necessarily be interpreted to exclude embodiments of the present disclosure.

In the present disclosure, the expressions “A or B,” “at least one of A or/and B,” or “one or more of A or/and B,” and the like, may include any and all combinations of the associated listed items. For example, the term “A or B,” “at least one of A and B,” or “at least one of A or B” may refer to all of the case (1) where at least one A is included, the case (2) where at least one B is included, or the case (3) where both of at least one A and at least one B are included. Furthermore, in describing an embodiment of the present disclosure, each of such phrases as “A or B,” “at least one of A and B,” “at least one of A or B,” “A, B, or C,” “at least one of A, B, and C,” “at least one of A, B, or C,” and “at least one of A, B, or C, or any combination thereof” may include any one of, or all possible combinations of, the items enumerated together in a corresponding one of the phrases. Particularly, the phrase such as “at least one of A, B, or C, or any combination thereof” may include “A,” “B,” or “C,” or “AB,” “BC,” “AC,” or “ABC,” which are various combinations thereof.

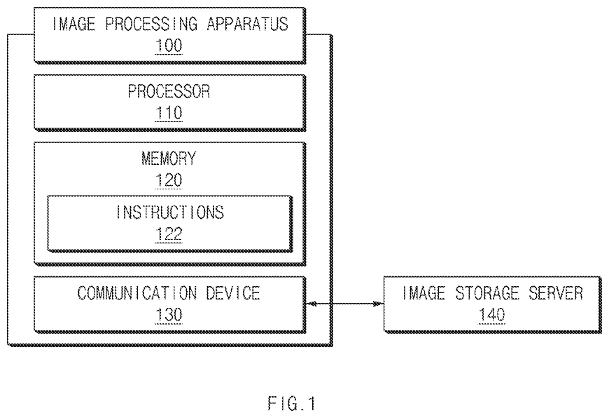

Hereinafter, embodiments of the present disclosure will be described in detail with reference to FIGS. 1 to 11.

FIG. 1 is a drawing illustrating an image processing apparatus according to an embodiment of the present disclosure.

An image processing apparatus 100, according to an embodiment, may include a processor 110, a memory 120 including code or instructions 122, and a communication device 130.

The image processing apparatus 100 may indicate an apparatus that obtains a defect type and a defect size of a car part detected from an image including the car part, based on detecting the part from the image. For example, the image processing apparatus 100 may preprocess an image around the part to generate an input image, based on detecting the part from the image. The image processing apparatus 100 may detect the part included in the image, based on a histogram of gradient (HOG), for expressing a distribution orientation of brightness as a histogram, and using the distribution orientation of brightness as a feature vector. An HOG algorithm may be an algorithm for extracting a feature of a part object, which may indicate an algorithm of dividing the image in the form of a checkerboard square and calculating a local histogram in a distribution orientation of brightness in each square grid.

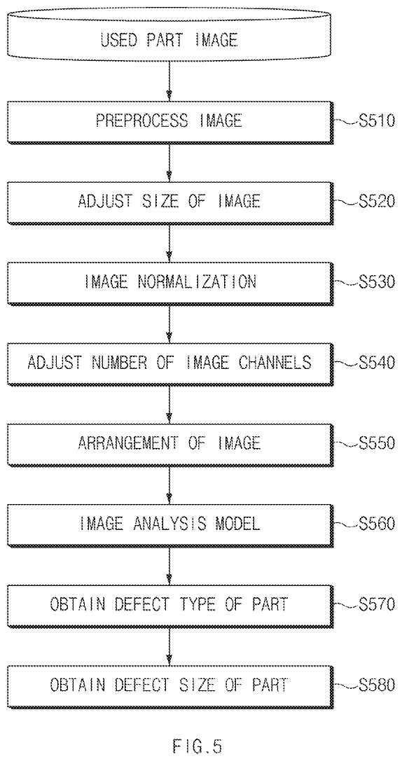

The image processing apparatus 100 may apply the input image to an image analysis model to obtain a degree to which the state of the part at a time point when the manufacture of the part is completed (e.g., original new-condition part) is different from a state of the part detected from the image. For example, the image analysis model may indicate a model that is trained by a machine learning method and processes an image for information (e.g., a defect type and a defect size of the part) to be obtained from the image. A detailed description of the image analysis model will be given below with reference to FIG. 5. The image processing apparatus 100 may obtain a state of the part detected from the image, by use of the defect type and the defect size of the part detected from the image.

The defect type of the part may include a first defect including a surface scratch of a painted surface area of the part, a second defect including shapeshifting of the part, a third defect in which a portion or all of the shape of the part is different from an existing shape of the part, and a fourth defect including a gap generated in a joint of the part.

The first defect may be about the surface scratch of the pointed surface area of the part, which may include at least one of a defect in which the coating on the part is peeled off, a defect in which a layer painted on the part is peeled off, a defect in which there is a scratch on an iron plate, or a defect in which there is a color different from an existing color of the part, or any combination thereof, for example.

The second defect may be about the shapeshifting of the part, which may include at least one of a defect in which there is a dug area in the part, a defect in which there is a recessed area in the part, a defect in which there is a crushed area in the part, or a defect in which there is a bent area in the part, or any combination thereof, for example.

The third defect may be that a shape of the part is different from the new original shape, which may include at least one of a defect in which the part is broken, a defect in which there is a damaged area on the part, a defect in which there is a torn area on the part, or a defect in which there is a perforated area in the part, or any combination thereof.

The fourth defect may be about a gap generated in the joint of the part, which may include at least one of a state in which each of the plurality of parts is out of alignment or a state in which a joint between a plurality of parts is open, or any combination thereof, for example.

The image processing apparatus 100 may calculate availability of the part depending on the defect size of the defect type. For example, the defect size may indicate a pixel amount of a defect degree in the image. The image processing apparatus 100 may calculate availability depending on the pixel amount of the defect degree in the image, based on the defect type and the defect size, which can be obtained by applying the input image to the image analysis model. In detail, when the defect size is less than 400 pixels, the image processing apparatus 100 may calculate the conclusion that the part with the defect size is similar to a new product and is an available part, for example. Furthermore, when the defect size is greater than or equal to 400 pixels and is less than 1500 pixels, the image processing apparatus 100 may calculate the conclusion that the part with the defect size has a slight damage, but is an available part, for example. When the defect size is greater than or equal to 1500 pixels and is less than 4000 pixels, the image processing apparatus 100 may calculate the conclusion that the part with the defect size has a lot of damage and is an unavailable part, for example. In detail, when the defect size is greater than or equal to 4000 pixels, the image processing apparatus 100 may calculate the conclusion that the part with the defect size is damaged and is an unavailable part, for example. For reference, it is described that the defect size is the pixel amount which is the area indicating the defect in the image for the convenience of description in the specification, but not necessarily limited thereto.

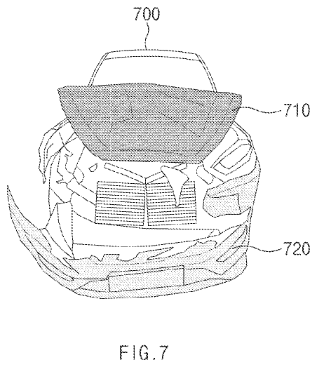

The image processing apparatus 100 may apply the defect type and the defect size to the input image to generate an output image. For example, the input image may indicate an image before being applied to the image analysis model. The image processing apparatus 100 may generate an input image by use of preprocessing of the image and may apply the generated input image to the image analysis model to obtain a defect type and a defect size. The image processing apparatus 100 may apply the obtained defect type and the obtained defect size to the input image. The image processing apparatus 100 may apply the defect type and the defect size to the input image to generate an output image. However, a method for generating the output image is not necessarily limited thereto. For example, the image processing apparatus 100 may apply the input image to the image analysis model to obtain an output image in which the defect type and the defect size are reflected. A detailed description of example output images will be described below with reference to FIGS. 7 to 10.

The processor 110 may execute software or code, and may control at least one other component (e.g., a hardware or software component) connected with the processor 110. In addition, the processor 110 may perform a variety of data processing or calculations. For example, the processor 110 may store the image, the input image, the output image, the defect type, and the defect size in the memory 120.

For reference, the processor 110 may perform all operations performed by the image processing apparatus 100. Therefore, for convenience of description in the specification, the operation performed by the image processing apparatus 100 is mainly described as an operation performed by the processor 110.

Furthermore, for convenience of description in the specification, the processor 110 is mainly described as one processor. For example, the image processing apparatus 100 may include at least one processor. Each of the at least one processor may perform part of the operations or all operations associated with an image processing operation.

The memory 120 may temporarily and/or permanently store various pieces of data and/or information required to perform image processing. For example, the memory 120 may store the image, the input image, the output image, the defect type, and the defect size.

The communication device 130 may assist in performing communication between the image processing apparatus 100 and an image storage server 140. For example, the communication device 130 may include one or more components for performing communication between the image processing apparatus 100 and the image storage server 140. For example, the communication device 130 may include a short range wireless communication unit, a microphone, or the like. At this time, a short range communication technology may be, but is not necessarily limited to, a wireless LAN (Wi-Fi), Bluetooth, ZigBee, Wi-Fi Direct (WFD), ultra-wideband (UWB), infrared data association (IrDA), Bluetooth low energy (BLE), near field communication (NFC), or the like, for example.

The image storage server 140 may provide a parts supplier that supplies used parts with the information received from the image processing apparatus 100. For example, the image storage server 140 may receive at least one of a defect type and a defect size of the part, which can be obtained by applying the image including the car part to the image analysis model, the image, or any combination thereof, from the image processing apparatus 100. The image received from the image processing apparatus 100 by the image storage server 140 may include the input image.

The image storage server 140 may provide an interface to receive a query about information of a used part from the parts supplier that supplies used parts. The parts supplier that supplies the used parts may query for information about the defect type of the part, the defect size of the part, and the image through the interface provided by the image storage server 140.

The image storage server 140 may provide the parts supplier that queries for the information with at least one of the defect type, the defect size, or the image, or any combination thereof, based on receiving the query about the information of the used part through the interface.

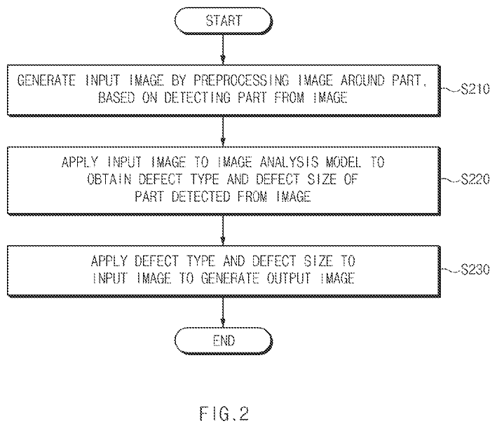

FIG. 2 is a flowchart for describing an image processing method according to an embodiment of the present disclosure.

In operation S210, an image processing apparatus (e.g., image processing apparatus 100 of FIG. 1) may preprocess an image around a part to generate an input image, based on detecting the part from the image. For example, the image may indicate an image stored in an image storage server (e.g., an image storage server 140 of FIG. 1) and may include a used car part. In detail, the image may mainly include a part with a defect among used car parts. The third party (e.g., a supplier which supplies used car parts) may store an image including a part in the image storage server. The image processing apparatus may obtain an image provided by the supplier from the image storage server. The image processing apparatus may detect a part from the obtained image. The image processing apparatus may preprocess the image around the part to generate the input image, based on detecting the part from the image.

In operation S220, the image processing apparatus may apply the input image to an image analysis model to obtain a defect type and a defect size of the part detected from the image. For example, the image processing apparatus may perform arrangement of pixels included in the input image in an order of channel features. The image processing apparatus may obtain the input vector including the above-mentioned pixels, by use of the arrangement of the pixels included in the input image in the order of channel features. However, the input vector is not necessarily limited thereto. For example, the image processing apparatus may extract a plurality of feature vectors from the input image. The plurality of feature vectors may include elements corresponding to the number of nodes of an input layer included in the image analysis model. The image processing apparatus may apply the input vector and/or the feature vectors to the nodes of the input layer included in the image analysis model to forward propagate the input vector and/or the feature vectors to an output layer through a link with a connection weight between a node of any layer and a node of another layer. The defect type and the defect size of the part may be obtained from the output layer included in the image analysis model, based on the input vector and/or the feature vectors being forward propagated in the image analysis model.

In operation S230, the image processing apparatus may apply the defect type and the defect size to the input image to generate an output image. For example, the image may indicate an original image including a car part. The output image may indicate an image in which the defect type and the defect size extracted by the image analysis model are reflected in the input image. The image processing apparatus may display an area where the part about the defect type and the defect size is located on the input image by a predetermined method.

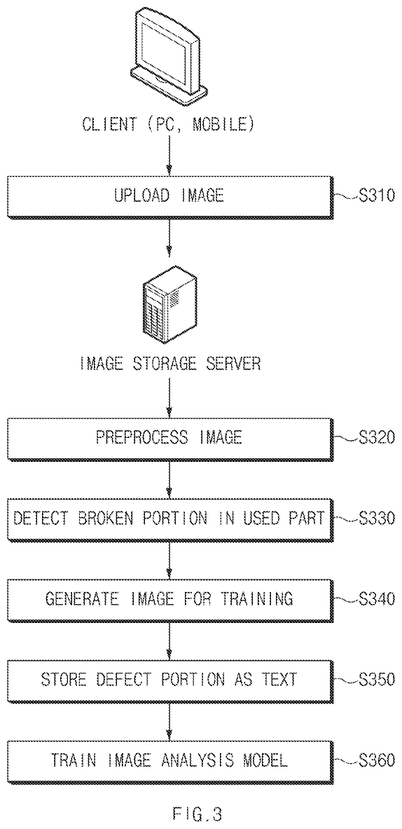

FIG. 3 is a drawing illustrating a method for training an image analysis model in an image processing apparatus, according to an embodiment of the present disclosure.

In operation S310, a third party (e.g., a supplier that supplies used car parts) may upload an image to an image storage server (e.g., an image storage server 140 of FIG. 1) by use of a portable terminal or a personal computer. The third party may upload an image file conforming to at least one of JPEG (jpg, jpeg), PNG (png), BMP (bmp), or any combination thereof, for example. Furthermore, the third party may upload an image file of a predetermined size or more. However, an upload requirement of the image file is not necessarily limited thereto. For example, the third party may upload an image file depending on a condition required in the image storage server. The above-mentioned condition may indicate a value initially set in the image storage server. This may be changed later by the image processing apparatus.

In operation S320, an image processing apparatus (e.g., an image processing apparatus 100 of FIG. 1) may preprocess the image uploaded to the image storage server. For example, a detailed description of preprocessing the image will be given below with reference to FIG. 5.

In operation S330, the image processing apparatus may detect a damaged part among the used parts from the preprocessed image. As a result, in operation S340, the image processing apparatus may generate an image for training of an image analysis model (e.g., an image for training). Furthermore, in operation S350, the image processing apparatus may store a defect type and a defect size about the damaged part as text. The image processing apparatus may generate an image for training of the image analysis model, and use a defect type and a defect size to train the image analysis model.

In operation S360, the image processing apparatus may train the image analysis model. Illustratively, the image analysis model may include a neural network. The neural network may include a plurality of layers. Each layer may include a plurality of nodes. The node may have a node value determined based on an activation function. A node of any layer may be connected with a node (e.g., another node) of another layer through a link (e.g., a connection edge) with a connection weight. The node value of the node may be propagated to other nodes through the link. In an inference operation of the neural network, node values may be forward propagated in the direction of a next layer from a previous layer.

Illustratively, the forward propagation calculation in the image analysis model may indicate calculation of propagating a node value based on input data, in the direction facing the output layer from the input layer of the image analysis model. In other words, a node value of the node may be propagated (e.g., forward propagated) to a node (e.g., a next node) of a next layer connected with the node through the connection edge. For example, the node may receive a value weighted by the connection weight from a previous node (e.g., a plurality of nodes) connected through the connection edge.

The node value of the node may be determined based on applying an activation function to a sum (e.g., weighted sum) of weighted values received from previous nodes. The parameter of the neural network may illustratively include the above-mentioned connection weight. The parameter of the neural network may be updated to be changed in a direction where an objective function, which will be described below, is targeted (e.g., a direction where a loss is minimized).

The trained image analysis model may indicate a model trained by use of machine learning and may be a trained machine learning model that outputs a training output (e.g., a defect type and a defect size) from a training input (e.g., an input image). In detail, the image processing apparatus may be a trained machine learning model that outputs pixels of a part included in the image (e.g., a location of the part in the image) and a state of the part (e.g., a defect degree of the part in the image) from the training input. However, the trained image analysis model is not necessarily limited thereto. For example, the trained image analysis model may be a trained machine learning model that outputs a training output (e.g., an output image to which a defect type and a defect size are applied) from a training input (e.g., an input image).

The machine learning model (e.g., the trained image analysis model) may be generated by use of machine learning. A learning algorithm may include, for example, but is not necessarily limited to, supervised learning, unsupervised learning, semi-supervised learning, or reinforcement learning, for example.

The machine learning model may include a plurality of artificial neural network layers. In detail, the trained image analysis model may include a shared layer including at least one convolution operation and a plurality of classifier layers (e.g., task-specific layers) connected with the shared layer. An artificial neural network may be, but is not necessarily limited to, a combination of at least one of a deep neural network (DNN), a convolutional neural network (CNN), a U-net for image segmentation (U-net), a recurrent neural network (RNN), a restricted Boltzmann machine (RBM), a deep belief network (DBN), a bidirectional recurrent deep neural network (BRDNN), deep Q-networks, or any combination thereof, for example.

For reference, based on the image analysis model being a U-Net neural network model, the image analysis model may include a plurality of pooling layers and a plurality of unpooling layers. The image processing apparatus may train the image analysis model, using a loss function defined as a sum of losses between the input image and the output image. A cross-entropy loss function may be used about the loss function. The plurality of pooling layers may be connected with non-linearity of a rectified linear unit (ReLU) included in the image analysis model. The image analysis model may include a skip connection from the plurality of pooling layers to the plurality of unpooling layers.

The image analysis model used by the image processing apparatus may have a basic U-Net backbone. U-Net may be composed of an encoder, a decoder, and a connection thereof. The encoder may generally extract a hierarchical structure of an image feature map from low complexity to high complexity, whereas the decoder may convert a feature and may reconfigure an output from low resolution to high resolution.

The image analysis model may include a convolution layer for performing linear transform operation, a batch normalization (BN) layer for performing normalization operation, a rectified linear unit (ReLU) layer for performing nonlinear function operation, and a channel concatenation layer or a channel sum layer for concatenating outputs of a plurality of layers.

For supervised learning, the above-mentioned machine learning model may be trained based on training data including a pair of a training input and a training output mapped to the training input. For example, the machine learning model may be trained to output a training output from a training input. The machine learning model while trained may output a temporary output in response to the training input and may be trained such that a loss of the temporary output and the training output (e.g., a training target) is minimized. A parameter of the machine learning model during a learning process (e.g., a connection weight between nodes/layers in the neural network) may be updated according to a loss. Such learning may be performed in the image processing apparatus itself in which the machine learning model is performed or may be performed by use of a separate server. The machine learning model, the training of which is performed (e.g., the trained image analysis model), may be stored in a memory (e.g., a memory 120 of FIG. 1).

For reference, the image processing apparatus may adjust at least one of a color feature of the training input, an edge feature of the training input, a polygon feature of the training input, a saturation feature of the training input, a color temperature feature of the training input, a definition feature of the training input, a contrast feature of the training input, a blur feature of the training input, a brightness feature, or any combination thereof, and may train the image analysis model for an image including the various features.

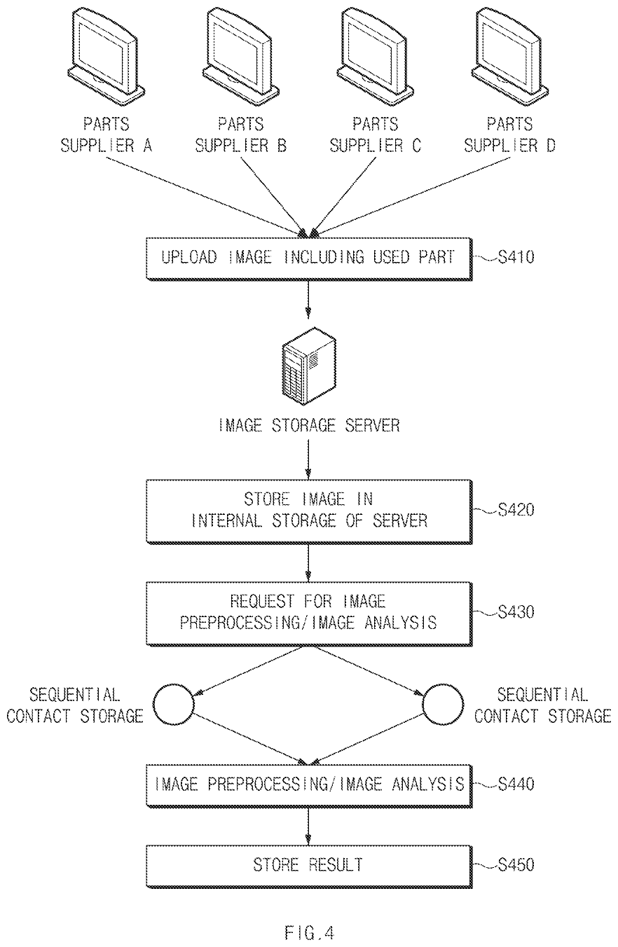

FIG. 4 is a drawing illustrating a process of processing an image in an image processing apparatus according to an embodiment of the present disclosure.

In operation S410, at least one third party (e.g., a supplier that supplies a used car part) may upload an image including a used car part to an image storage server (e.g., an image storage server 140 of FIG. 1). An image processing apparatus (e.g., an image processing apparatus 100 of FIG. 1) may provide an interface to receive an image from a parts supplier that supplies used parts.

In operation S420, the image processing apparatus may store the image uploaded by the third party in internal storage of the image storage server. As a result, the image processing apparatus may manage an image including defect information by use of a server, thus minimizing an error generated as recorded by the hand of the user.

In operation S430, the image processing apparatus may respond to a request of the user for image preprocessing and a request for an image analysis. For example, in response to the above-mentioned request of the user, in operation S440, the image processing apparatus may preprocess the image to generate an input image and may perform an image analysis. For example, the image processing apparatus may apply the input image to an image analysis model to obtain a defect type and a defect size of the part detected from the image, thus performing an image analysis.

In operation S450, the image processing apparatus may concatenate the image, the input image, and the output image, and may transmit the concatenated image to the image storage server. The output image may include an image in which the defect type and the defect size, which are obtained as the image processing apparatus applies the input image to the image analysis model, are reflected.

FIG. 5 is a drawing illustrating a method for applying an input image to an image analysis module in an image processing apparatus, according to an embodiment of the present disclosure.

In operation S510, an image processing apparatus (e.g., an image processing apparatus 100 of FIG. 1) may preprocess an image around a part, based on detecting the part from the image. For example, the image processing apparatus may preprocess the image through operations S520 to S550, which will be described below.

In operation S520, the image processing apparatus may adjust a size of the image. The image processing apparatus may generate an input image by use of a cropped image including a selected (e.g., preset or predetermined) area including all portions of the detected part.

In operation S530, the image processing apparatus may apply normalization to pixel values included in the cropped image depending on a selected (e.g., preset or predetermined) pixel interval to change the pixel values. However, the normalization of the cropped image is not necessarily limited thereto. For example, the image processing apparatus may apply normalization to the pixel values included in the cropped image depending on a selected (e.g., preset or predetermined) binary pixel. The pixels of the cropped image to which the normalization is applied may indicate at least one of, for example, a pixel value indicating “o” or a pixel value indicating “1.”

In operation S540, the image processing apparatus may adjust the number of channels of the cropped image. For example, the image processing apparatus may change a channel of the cropped image, the pixel values of which are changed through the normalization, to a first channel or a second channel. The first channel may indicate an RGB channel and the second channel may indicate a grayscale channel, for example.

In operation S550, the image processing apparatus may change a plurality of pixel values included in the cropped image, the pixel values of which are changed, to a one-dimensional array in an order of channel features included in the first channel, based on the channel of the crop image, the pixel values of which are changed, changes to the first channel including the plurality of channels. In other words, the image processing apparatus may obtain an input vector including the above-mentioned pixels, by use of arrangement of the pixels included in the input image in the order of channel features. Furthermore, the image processing apparatus may change the plurality of pixel values included in the cropped image, the pixel values of which are changed, to a one-dimensional array in an order where the plurality of pixels are stored, based on the channel of the cropped image, the pixel values of which are changed, changes to the second channel including the plurality of channels.

Finally, in operations S560 to S580, the image processing apparatus may apply the input image, the preprocessing of which is completed, to an image analysis model to obtain a defect type and a defect size of the part detected from the image.

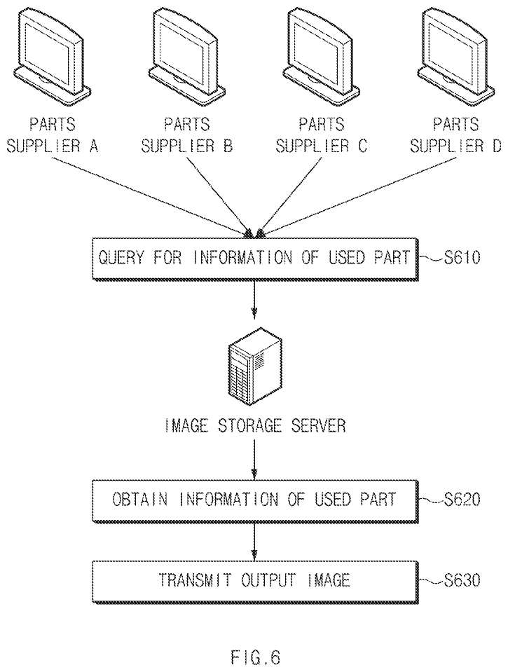

FIG. 6 is a drawing illustrating a process of querying for an output image in an image processing apparatus, according to an embodiment of the present disclosure.

In operation S610, at least one third party (e.g., a supplier t supplies a used car part or a purchaser who purchases a used car part) may query for information of a used part. For example, an image processing apparatus (e.g., an image processing apparatus 100 of FIG. 1) may provide the at least one third party with an output image, a defect type, and a defect size, which are stored in an image storage server (e.g., an image storage server 140 of FIG. 1), through an interface, in response to the query of the at least one third party.

In operation S620, the image processing apparatus may obtain the information of the used part from the image storage server. For example, the image processing apparatus may obtain the information of the used part based on the output image, the defect type, and the defect size.

In operation S630, the image processing apparatus may transmit the information of the used part the at least one third party queries for as an output image. For example, the image processing apparatus may provide the at least one third party with the information of the used part with which the obtained output image, the obtained defect type, and the obtained defect size are connected.

FIG. 7 is a drawing illustrating a generated output image in an image processing apparatus, according to an embodiment of the present disclosure.

An image processing apparatus (e.g., an image processing apparatus 100 of FIG. 1) may apply an input image to an image analysis model to obtain a defect type and a defect size of a part detected from an image, and may apply the defect type and the defect size to the input image to generate an output image 700. For example, the output image 700 may include at least one used car part. Referring to FIG. 7, the output image 700 may include a first part 710 and a second part 720. For reference, for convenience of description in the specification, used car parts are mainly described as parts that are damaged and defective.

The first part 710 may indicate a hood (bonnet) of a vehicle, and the second part 720 may indicate a front bumper of the vehicle. The image processing apparatus may obtain defect information (e.g., a defect type and a defect size) of a part included in an original image of the output image 700 (e.g., an image before the input image is preprocessed). The image processing apparatus may apply the defect information to the input image to generate the output image 700.

In conjunction with the first part 710, the image processing apparatus may apply the defect type and the defect size of the hood to the input image, on the basis of the position of the hood of the vehicle. As a result, the image processing apparatus may generate the output image 700 to which the defect information of the first part 710 is applied.

In conjunction with the second part 720, the image processing apparatus may apply the defect type and the defect size of the front bumper to the input image, based on the position of the front bumper of the vehicle. As a result, the image processing apparatus may generate the output image 700 to which the defect information of the second part 720 is applied.

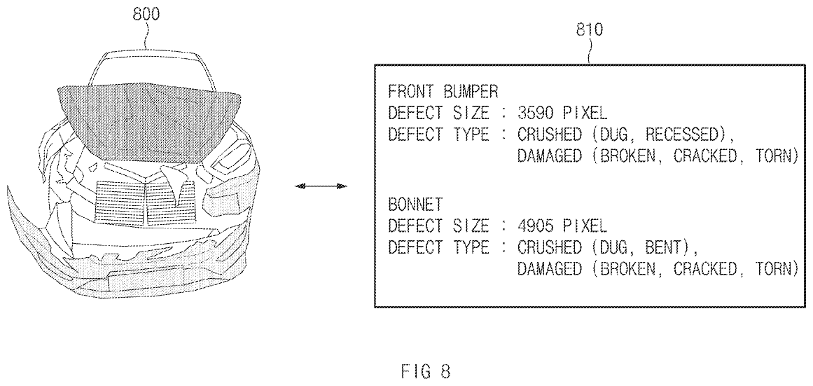

FIG. 8 is a drawing illustrating defect information paired with a generated output image in an image processing apparatus, according to an embodiment of the present disclosure.

An image processing apparatus (e.g., an image processing apparatus 100 of FIG. 1) may provide an output image 800 and defect information 810, which are stored in an image storage server (e.g., an image storage server 140 of FIG. 1), through an interface. The defect information 810 may include defect types of parts included in the output image 800 and defect sizes corresponding to the defect types.

In conjunction with the front bumper included in the output image 800, the defect information 810 may include a defect size of the front bumper (e.g., which is illustrated as 3590 pixels in FIG. 8) and a defect type of the front bumper (e.g., which is about shapeshifting of the part in FIG. 8 and is illustrated as being crushed and damaged, as the shape of the part is different from a new or original shape). In other words, the defect information 810 may include a second defect, a third defect, and a defect size of the front bumper. Furthermore, because the defect size of the front bumper is greater than or equal to 1500 pixels and is less than 4000 pixels, the image processing apparatus may calculate the conclusion that the front bumper is a part that has a lot of damage and is unavailable, for example.

In conjunction with the hood included in the output image 800, the defect information 810 may include a defect size of the hood (e.g., which is illustrated as 4905 pixels in FIG. 8) and a defect type of the hood (e.g., which is about shapeshifting of the part in FIG. 8 and is illustrated as being crushed and damaged as the shape of the part is different from a new or original shape). In other words, the defect information 810 may include a second defect, a third defect, and a defect size of the hood. Furthermore, because the defect size of the hood is greater than or equal to 4000 pixels, the image processing apparatus may calculate the conclusion that the hood is a part that is damaged and is unavailable, for example.

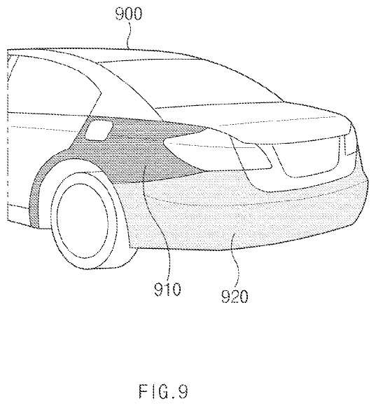

FIG. 9 is a drawing illustrating a generated output image in an image processing apparatus, according to an embodiment of the present disclosure.

An image processing apparatus (e.g., an image processing apparatus 100 of FIG. 1) may apply an input image to an image analysis model to obtain a defect type and a defect size of a part detected from an image and may apply the defect type and the defect size to the input image to generate an output image 900. For example, the output image 900 may include at least one used car part. Referring to FIG. 9, the output image 900 may include a first part 910 and a second part 920. For reference and for convenience of description in this specification, used car parts are mainly described as parts that are damaged and defective, for example.

The first part 910 may indicate a side fender of a vehicle, and the second part 920 may indicate a rear bumper of the vehicle. The image processing apparatus may obtain defect information (e.g., a defect type and a defect size) of a part included in an original image of the output image 900 (e.g., an image before the input image is preprocessed). The image processing apparatus may apply the defect information to the input image to generate the output image 900.

In conjunction with the first part 910, the image processing apparatus may apply the defect type and the defect size of the side fender to the input image, based on the position of the side fender of the vehicle. The image processing apparatus may generate the output image 900 to which the defect information of the first part 910 is applied.

In conjunction with the second part 920, the image processing apparatus may apply the defect type and the defect size of the rear bumper to the input image, based on the position of the rear bumper of the vehicle. The image processing apparatus may generate the output image 900 to which the defect information of the second part 920 is applied.

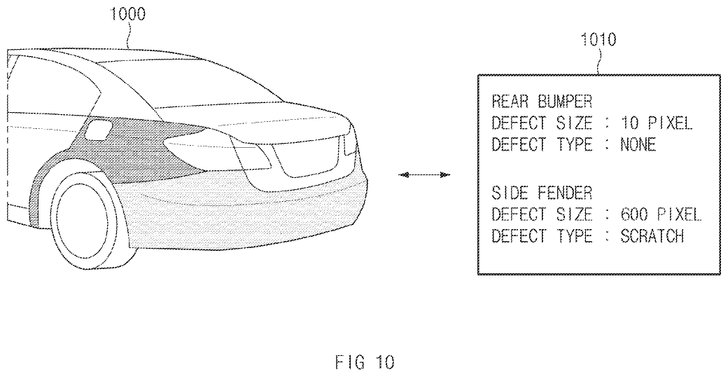

FIG. 10 is a drawing illustrating defect information paired with a generated output image in an image processing apparatus, according to an embodiment of the present disclosure.

An image processing apparatus (e.g., an image processing apparatus 100 of FIG. 1) may provide an output image 1000 and defect information 1010, which can be stored in an image storage server (e.g., an image storage server 140 of FIG. 1), through an interface. The defect information 1010 may include defect types of parts included in the output image 1000 and defect sizes corresponding to the defect types.

In conjunction with the side fender included in the output image 1000, the defect information 1010 may include a defect size of the side fender (e.g., which is illustrated as 10 pixels in FIG. 10) and a defect type of the side fender (e.g., which is illustrated as none in FIG. 10). In other words, the defect information 1010 may include a state that does not correspond to any of first to fourth defects of the side fender and a defect size. Furthermore, because the defect size of the side fender is less than 1500 pixels, the image processing apparatus may calculate the conclusion that the side fender is a part which has slight damage and is available, for example.

In conjunction with the rear bumper included in the output image 1000, the defect information 1010 may include a defect size of the rear bumper (e.g., which is illustrated as 600 pixels in FIG. 10) and a defect type of the rear bumper (e.g., which is about shapeshifting of the part in FIG. 10 and is illustrated as “scratch”). In other words, the defect information 1010 may include a first defect and a defect size of the rear bumper. Furthermore, because the defect size of the rear bumper is less than 1500 pixels, the image processing apparatus may calculate the conclusion that the rear bumper is a part which has slight damage and is available, for example.

The method discussed above is part of the assembly process of a vehicle. In this process, the vehicle is assembled and inspected. Upon determining that a particular part is damaged and unavailable, the part may be replaced and assembly of the vehicle may continue with the replacement part. The damaged part can then be scrapped or recycled.

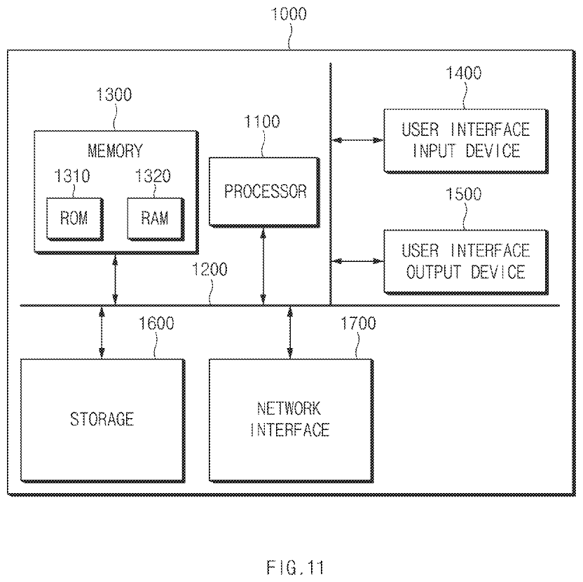

FIG. 11 is a drawing illustrating a computing system associated with an image processing apparatus and a method thereof according to an embodiment of the present disclosure.

Referring to FIG. 11, in some embodiments, a computing system 1000 about the image processing apparatus and the method thereof may include at least one processor 1100, a memory 1300, a user interface input device 1400, a user interface output device 1500, storage 1600, and a network interface 1700, which are connected with each other via a bus 1200, for example.

The processor 1100 may be a central processing unit (CPU) or a semiconductor device that processes code or instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments disclosed in the specification may be directly implemented with a hardware module, a software module, or a combination of the hardware module and the software module, which is executed by the processor 1100. The software module or code may reside on a storage medium (that is, the memory 1300 and/or the storage 1600) such as a RAM, a flash memory, a ROM, an EPROM, an EEPROM, a register, a hard disc, a removable disk, and a CD-ROM.

The example storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Hereinabove, although embodiments of the present disclosure has been described with reference to example embodiments and the accompanying drawings, the present disclosure is not necessarily limited thereto, and may be variously modified and altered by those skilled in the art to which the present disclosure pertains without departing from the spirit and scope of the present disclosure claimed in the following claims.

The above-described embodiments may be implemented with hardware elements, software elements, and/or a combination of hardware elements and software elements. For example, the devices, methods, and components described in the embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit may perform an operating system (OS) or a software application running on the OS. Further, the processing unit may access, store, manipulate, process, and generate data in response to execution of software or code. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions, or one or more combinations thereof, and may configure a processing unit to operate in a desired manner or may independently or collectively instruct the processing unit. Software and/or data may be permanently or temporarily embodied in any type of machine, components, physical equipment, virtual equipment, computer storage media or units, or transmitted signal waves, so as to be interpreted by the processing unit or to provide instructions or data to the processing unit. Software may be dispersed throughout computer systems connected via networks and may be stored or executed in a dispersion manner. Software and data may be recorded in one or many computer-readable storage media.

The methods according to embodiments may be implemented in the form of code or program instructions that may be executed through various computer devices, and may be recorded in computer-readable media. The computer-readable media may include code, program instructions, data files, data structures, and the like, alone or in combination, and the code or program instructions recorded on the media may be specially designed and configured, for example, or may be known and usable to those skilled in the art of computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like, for example. Program code and instructions can include both machine codes, such as produced by a compiler, higher level codes that may be executed by the computer using an interpreter, or combinations thereof, for example.

The above-described hardware devices may be configured to act as one or a plurality of software modules to perform the operations of the embodiments, or vice versa.

Even though some embodiments are described with reference to restricted drawings, it may be apparent to one skilled in the art that embodiments can be variously changed or modified, based on and in hindsight of the above description. For example, adequate effects may be achieved even if the foregoing processes and methods are carried out in different order than described above, and/or the aforementioned elements, such as systems, structures, devices, or circuits, are combined or coupled in different forms and modes than as described above or can be substituted or switched with other components or equivalents.

According to at least one embodiment of the present disclosure, an image processing apparatus may obtain a defect type and a defect size of a detected part based on detecting the part from an image to reduce a time for identifying a defect of a used car part and may exclude subjective judgment of the user to increase the reliability of the state of the used part, thus maintaining certain inspection quality.

Furthermore, according to at least one embodiment of the present disclosure, an image processing apparatus may calculate availability of the part and a range of breakage of the part based on the defect size obtained from the image analysis model to provide stakeholders associated with the transaction of the used car part with accurate and reliable information about the state of the used part, and may exclude subjective judgment of the user to overcome the limit of the inspection result based on the experience of the user.

Furthermore, according to at least one embodiment of the present disclosure, an image processing apparatus may increase the accuracy of entering information for the sale of the used part through an interface for receiving or providing an image, may develop a healthy trading ecosystem for used car parts to develop parts industry, and may reduce carbon emissions due to the activation of the used parts industry.

In addition, various effects ascertained directly or indirectly through the present disclosure may be provided.

Therefore, other implements, other embodiments, and equivalents to claims are within the scope of the following claims.

Therefore, embodiments of the present disclosure are not necessarily intended to limit the technical spirit of the present disclosure, and can be provided merely for illustrative purposes. The scope of the present disclosure should be construed based on the accompanying claims, and all technical ideas within the scope equivalent to the claims can be included in the scope of the present disclosure.

What is claimed is:

1. An image processing apparatus, comprising:
a memory storing computer-executable code; and
at least one processor configured to access the memory and execute the code, wherein the code comprises instructions for the at least one processor to generate an input image by preprocessing an image around a part, based on detecting the part from the image, apply the input image to an image analysis model to obtain a defect type and a defect size of the part detected from the image, and apply the defect type and the defect size to the input image to generate an output image.

2. The apparatus of claim 1, wherein the code comprises instructions for the at least one processor to generate the input image by use of a cropped image including a selected area, wherein the selected area includes all portions of the detected part, and apply normalization to pixel values included in the cropped image depending on a selected pixel interval to change the pixel values.

3. The apparatus of claim 2, wherein the code comprises instructions for the at least one processor to:
change a channel of the cropped image, the pixel values of which are changed, to a first channel or a second channel,
change a plurality of pixel values included in the cropped image, the pixel values of which are changed, to a one-dimensional array in an order of channel features included in the first channel changes to the first channel including a plurality of channels, based on the channel of the cropped image, the pixel values of which are changed.

4. The apparatus of claim 3, wherein the code comprises instructions for the at least one processor to concatenate the image, the input image, and the output image, and transmit the concatenated image to an image storage server.

5. The apparatus of claim 1, wherein the code comprises instructions for the at least one processor to adjust one of or any combination of a color feature of the input image, an edge feature of the input image, a polygon feature of the input image, a saturation feature of the input image, a color temperature feature of the input image, a definition feature of the input image, a contrast feature of the input image, a blur feature of the input image, and a brightness feature of the input image, and apply the adjusted image to the image analysis model to obtain the defect type and the defect size.

6. The apparatus of claim 1, wherein the defect type comprises:
a first defect including a surface scratch of a painted surface area of the part;
a second defect including shapeshifting of the part;
a third defect in which at least a portion of a shape of the part is different from an existing shape of the part; and
a fourth defect including a gap generated in a joint of the part.

7. The apparatus of claim 1, wherein the code comprises instructions for the at least one processor to calculate availability of the part and a range of breakage of the part, based on the obtained defect size.

8. The apparatus of claim 1, wherein the code comprises instructions for the at least one processor to provide an interface to receive the image from a parts supplier supplying used parts and provide the parts supplier with the output image, the defect type, and the defect size stored in an image storage server through the interface.

9. The apparatus of claim 1, wherein the code comprises instructions for the at least one processor to generate the image analysis model including a plurality of pooling layers and a plurality of unpooling layers, based on the image analysis model being a U-Net neural network model, and train the image analysis model, using a loss function defined as a sum of losses between the input image and the output image.

10. The apparatus of claim 9, wherein the plurality of pooling layers are connected with non-linearity of a rectified linear unit (ReLU) function included in the image analysis model, and wherein the image analysis model includes a skip connection from the plurality of pooling layers to the plurality of unpooling layers.

11. An image processing method, comprising:
generating an input image by preprocessing an image around a part, based on detecting the part from the image;
applying the input image to an image analysis model to obtain a defect type and a defect size of the part detected from the image; and
applying the defect type and the defect size to the input image to generate an output image.

12. The method of claim 11, wherein the generating of the input image comprises:
generating the input image by use of a cropped image including a selected area including all portions of the detected part; and
applying normalization to pixel values included in the cropped image depending on a selected pixel interval to change the pixel values.

13. The method of claim 12, further comprising:
changing a channel of the cropped image, the pixel values of which are changed, to a first channel or a second channel; and
changing a plurality of pixel values included in the cropped image, the pixel values of which are changed, to a one-dimensional array in an order of channel features included in the first channel changes to the first channel including a plurality of channels, based on the channel of the cropped image, the pixel values of which are changed.

14. The method of claim 13, further comprising:
concatenating the image, the input image, and the output image; and
transmitting the concatenated image to an image storage server.

15. The method of claim 11, wherein the obtaining of the defect type and the defect size comprises:
adjusting one of or any combination of a color feature of the input image, an edge feature of the input image, a polygon feature of the input image, a saturation feature of the input image, a color temperature feature of the input image, a definition feature of the input image, a contrast feature of the input image, a blur feature of the input image, and a brightness feature of the input image; and
applying the adjusted image to the image analysis model to obtain the defect type and the defect size.

16. The method of claim 11, wherein the defect type comprises:
a first defect including a surface scratch of a painted surface area of the part;
a second defect including shapeshifting of the part;
a third defect in which at least a portion of a shape of the part is different from an existing shape of the part; and
a fourth defect including a gap generated in a joint of the part.

17. The method of claim 11, further comprising calculating availability of the part and a range of breakage of the part, based on the obtained defect size.

18. The method of claim 11, further comprising:
providing an interface to receive the image from a parts supplier supplying used parts; and
providing the parts supplier with the output image, the defect type, and the defect size stored in an image storage server through the interface.

19. The method of claim 11, further comprising:
generating the image analysis model including a plurality of pooling layers and a plurality of unpooling layers, based on the image analysis model being a U-Net neural network; and
training the image analysis model, using a loss function defined as a sum of losses between the input image and the output image,
wherein the plurality of pooling layers are connected with non-linearity of a rectified linear unit (ReLU) function included in the image analysis model, and
wherein the image analysis model includes a skip connection from the plurality of pooling layers to the plurality of unpooling layers.

20. An image processing method, comprising:
receiving from an image processing apparatus one of or any combination of an image including a part of a vehicle, a defect type of the part of the vehicle, and a defect size of the part of the vehicle, wherein one of or both of the defect type and the defect size are obtained by applying the image to an image analysis model;
providing an interface to receive a query about information of a used part from a parts supplier supplying used parts; and
providing the parts supplier with one of or any combination of the defect type, the defect size, and the image, based on receiving the query about the information of the used part through the interface.
